(19) United States
(12) Patent Application Publication
(10) Pub. No.: US 2002/0112308 A1
(43) Pub. Date: Aug. 22, 2002

(54) Wiper device, in particular for motor vehicle

(76) Inventors: Joachim Zimmer, Sasbach (DE); Harald Rapp, Buehl (DE)

Correspondence Address: STRIKER, STRIKER & STENBY, 103 East Neck Road, Huntington, NY, 11743, US

(21) Appl. No.: 10/078,990

(22) Filed: Feb. 19, 2002

(30) Foreign Application Priority Data
Feb. 21, 2001 (DE) 101 08 184.7

(51) Int. Cl. B60S 1/32; B60S 1/34

(52) U.S. Cl. 15/250.352; 15/250.351

(57) ABSTRACT

A window wiper device for a motor vehicle has a wiper arm having at least one hinge part and a mounting part hingedly connected with the hinge part, at least one pulling element which connects the mounting part with the hinge part, the mounting part having substantially a profile with a base and at least one lateral flank, the pulling element being mounted on the mounting part on a shackle extending from the lateral flank.

### BACKGROUND OF THE INVENTION

The present invention relates to a wiper device, in particular for a motor vehicle.

Numerous wiper devices of this type are known in the art. One of such devices is disclosed for example in the European patent document EP 0 579 500. In this device the supporting force with which the wiper blade is pressed against the window of the motor vehicle is actuated by a spring which is mounted on the wiper arm.

For this purpose the wiper arm has a substantially elongated hinge part, and the wiper blade is hinged on one end. The other end is hingedly connected with also a substantially elongated mounting part which is mounted on the wiper shaft of the wiper device for joint rotation therewith. The hinge part and the mounting part have both a cross-section with a substantial U-shaped and are rotatably connected for example by a pin.

For obtaining the supporting force, a pulling spring is provided at a side of the hinged connection between the hinged part and the mounting part, which faces the window. The mounting part for this purpose has a pin, and one side of a C-shaped bracket is hooked on its one side. An end of the pulling spring is hooked on the other side of the bracket and its opposite end is fixed by a further pin on the hinge part. It is believed that the existing construction can be further improved.

### SUMMARY OF THE INVENTION

Accordingly, it is an object of the present invention to provide a wiper device of the above mentioned general type, which is a further improvement of the existing devices.

In keeping with these objects and with others which will become apparent hereinafter, one feature of the present invention resides, briefly stated in a window wiper device for a motor vehicle, comprising a wiper arm having at least one hinge part and a mounting part hingedly connected with said hinge part; at least one pulling means which connects said mounting part with said hinge part, said mounting part having substantially a profile with a base and at least one lateral flank, said pulling means being mounted on said mounting part on a shackle extending from said lateral flank.

When the window wiper device is designed in accordance with the present invention, it has the advantage that due to the hinge connection of a pulling means on a shackle of the mounting part, a pin on the mounting part can be dispensed with. Thereby the number of the required working steps is reduced, since the mounting part normally is produced in punching-bending process. In this step also the shackle can be punched out and bent, so that insertion of a rivet or a pin is dispensed with. This economizes the resources, material and manufacturing costs. Moreover, the wiper arm can be formed flatter.

It is especially advantageous when in accordance with the present invention the shackle, starting from the edge of the lateral flank of the mounting part which faces away from the base, extends substantially parallel to the base or perpendicular to the lateral flank. This guarantees a torsion-loading free suspension of the pulling means.

It is further advantageous when in accordance with the present invention the shackle is formed of one piece with the mounting part, since the shackle is connected stably with the mounting part and no further expensive and failure-susceptible mounting technique must be used, such as for example welding, glueing, etc.

It is especially advantageous when furthermore the shackle is arranged at the hinge-side half of the mounting part, preferably in a longitudinal extension of the mounting part at the side of the hinge. In this manner, the mounting region of the pulling means extends over the hinge region between the hinge part and the mounting part, so that the pulling region of the pulling means must not be bent.

The shackle can be provided with an opening for mounting of the pulling means. Therefore, the pulling means can be hooked fast and reliable in the mounting part in a mass production of the device.

The pulling means can be composed at least of a pulling spring and a C-shaped bracket. Thereby a cost favorable mass produced element is formed as a pulling means.

The opening in which the pulling means, in particular the bracket of the pulling means is hooked is reinforced at least at the location which contacts the pulling means. As a result the wear of this connection is advantageously minimized.

Furthermore, the shackle can have a supporting projection. In this construction the loading of the shackle, in particular in a folded position when the wiper blade does not contact the window is reduced, and a possible bending of the shackle is prevented.

It is especially advantageous when the supporting projection for supporting the shackle on the base extends from an edge of the shackle substantially perpendicular to the base. This is true especially when the supporting projection is formed of one piece with the shackle, since therefore the complete mounting part with the shackle and the supporting projection can be formed of one piece in a punching-bending process.

A gap can be provided between the shackle-remote end of the supporting projection and the base so as to compensate for manufacturing tolerances. By applying the spring force fo the pulling means in the folding position, the shackle can be bent in direction of the base. Thereby an elastic deformation is provided and a contact between the supporting projection and the base, so as to prevent a further plastic deformation of the shackle.

It is also advantageous when the shackle has a projection which substantially closes the interior of the profile of the mounting part. The shackle in this case serves as a holder for a washing fluid hose of the window washing device.

It is especially advantageous when the pulling means is mounted on the hinge part and in some cases with the mounting shackle, which is arranged substantially in the same plane as the shackle of the mounting part when the hinge part and the mounting part are in a working condition. In other words it is especially advantageous when between the lateral flank of the mounting part and the shackle, an angle is enclosed which is substantially equal to the angle enclosed by the mounting shackle of the hinge part with the hinge part flank. In this way a torsion-load free suspension of the pulling means is possible, when its mounting is also located substantially in one plane. This is the case for example with conventional pulling springs with brackets.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic view of a window wiper device in accordance with the present invention;

FIG. 2 is a view showing wiper arm in accordance with the prior art, in a perspective;

FIG. 3 is a perspective view of a spring suspension of the inventive window wiper device in a folded position; and

FIG. 4 is a perspective view of a spring suspension of the inventive window wiper device in a working position.

### DESCRIPTION OF THE PREFERRED EMBODIMENTS

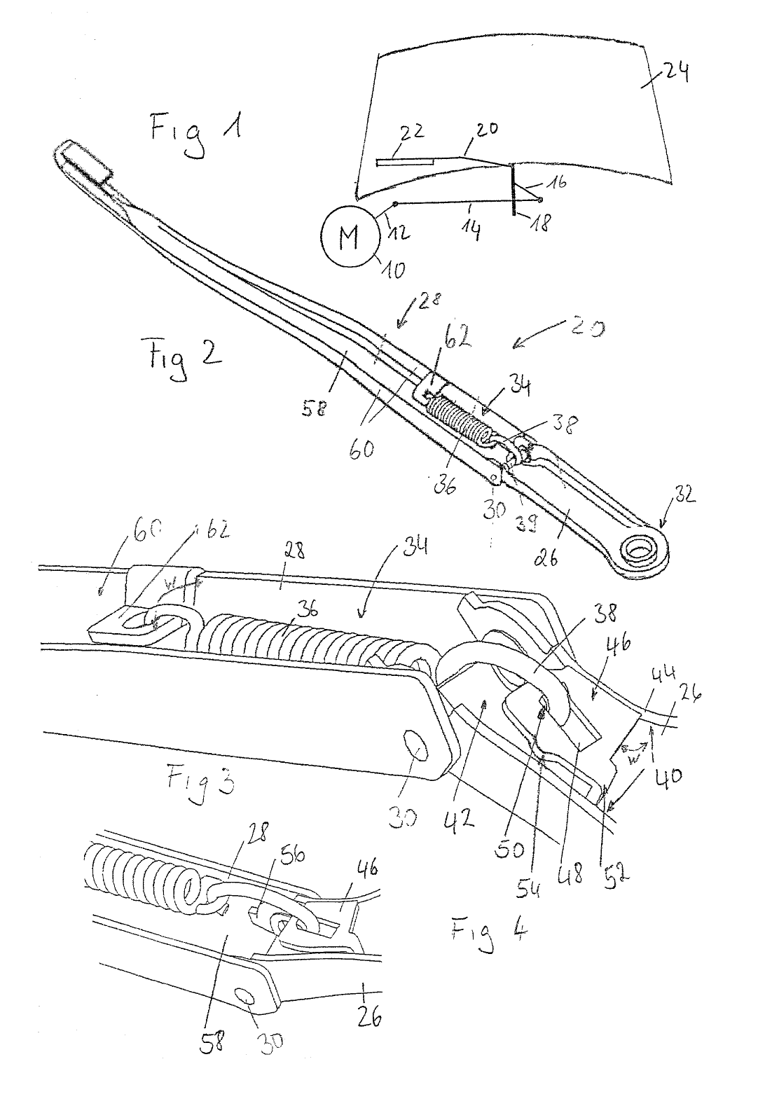

FIG. 1 schematically shows an inventive window wiper device. A motor 10 moves a crank 12 which swingingly drives a wiper shaft 18 through a rod 14 and a lever 16. A wiper arm 20 is connected at one end with the wiper shaft 18 for joint rotation. At its another end it carries a wiper blade 22. It can slide over a window 24.

FIG. 2 shows a wiper arm 20 with its components in a perspective view. It includes substantially a mounting part 26 which is connected for joint rotation with a hinge part 28. The hinge part 28 is of a substantially elongated U-shaped design with a hinge part base, a front and a rear hinge part flank 60, and a mounting device at its one end hingedly connectable with the wiper blade 22. At its another end it is connected through a hinge pin 30 with a mounting part 26 which also has a substantially elongated design.

The mounting part 26 at its end which faces away of the hinge part 28 has a lug 32 for connection to the wiper shaft 18 for joint rotation with it. Outside or the hinge pin 36 the mounting part 26 and the hinge part 28 are connected with one another via a pulling means 34. The pulling means 34 includes a pulling spring 36 and a C-shaped bracket 38 which is hooked in a pulling means pin 39. Since the mounting part 26 is rigidly connected with the wiper shaft 18, the hinge part 28 is pulled by the pulling means 34 in direction of the window 24. Thereby the wiper blade 22 is pressed with an supporting force F against the window 24. The pulling means pin 39 for this purpose is arranged naturally substantially parallel to the hinge pin 30, but substantially close to the window 24. In the drawing the hinge pin 30 is somewhat covered by the pulling means pin 31.

FIG. 3 shows the connecting region between the hinge part 28 and the mounting part 26 with the pulling means 34 in detail.

The mounting part 26 in a cross-section has substantially a U-shaped design. The both legs form two lateral flanks 40 which are connected with one another by a base 42. A shackle 46 is arranged at the lateral edge 44 of the lateral flank 40 which faces away from the base 42. It is formed of one piece with the lateral flank 40 and bent substantially perpendicular to the lateral flank 40, so that it extends substantially parallel to the base 42. The shackle 46 can naturally be mounted also in another way, for example by welding or glueing. The shackle 46 moreover has an opening 48, in which the C-shaped bracket 38 is hooked. The shackle 46 replaces thereby the pulling means pin 39 of FIG. 2.

Since the shackle 46 has a material thickness of substantially 0.5 mm, the bracket 38 which normally has a round cross-section abuts on two abutment points on the upper and lower side of the shackle 46. For avoiding these loading points which reduce the wear strength of the connection, in this region an abutment element 51 is arranged. It is formed so that the abutment region of the bracket 38 on the opening 48 corresponds at least to a line, if not to a surface. For this purpose during punching of the opening 48 for example a small bead can be bent or punched as an abutment element 51.

The hinge part 28 is shown in FIG. 2 in a folded position, which for example is the case during exchange of the wiper blades 22. The force action of the pulling means 34 has in this position a considerable component in the direction which tries to bend the shackle 46 to the base 42. In order to avoid this, the shackle 46 has a supporting projection 52. It is arranged in an edge region of the shackle 46 which is remote from the lateral flank 40 mounted on the shackle 46. For compensation of the manufacturing tolerances it is possible instead of abutment of the supporting projection 52 on the base 42, to form it so that a small gap is provided between the shackle-remote end of the supporting projection 52 and the base 42. The gap must be such that in the case of loading only an elastic deformation of the shackle in direction to the base is possible. Before transiting to a plastic deformation, the shackle is then supported on the base 42 by the supporting projection 52.

Furthermore, the shackle 46 has a projection 54 which has such a dimension that between the projection 54 and the wiper flank 40 on which the shackle 46 is not mounted, only such a distance remains that an elastic hose for transporting a washing fluid of a window washing device can be pressed through it or pressed out. Also, the gap between the projection 54 and the lateral flank 40 which is opposite to the projection 54 is smaller than the normal diameter of a washing fluid hose of a window washing device. Naturally, also the supporting projection 52 can be formed so that it can serve for guiding a washing fluid hose.

For mounting of the pulling spring 36 of the hinge part 28, it has a mounting shackle 62 which extends from the edge of the hinge part flank 60 facing away from the hinge space 58, inwardly to the hinge part base 58 and encloses an angle W with the hinge part flank 60. Since the mounting shackle 62 can have several portions, the pulling spring 36 is mounted in the portion of the mounting shackle 62 which encloses an angle W with the hinge part flank 60, which is substantially equal to an angle between the portion of the shackle 46 on which the bracket 38 is hooked and the lateral flank 40 of the mounting part 26.

FIG. 4 shows the connection between the hinge part 28 and the mounting part 26, however in the working position in which the wiper blade 22 is in contact with the window 24. The shackle 46 is arranged in the region of the hinge pin 30, and thereby in the hinge part-side quarter of the mounting part 26. In order to limit the rotary angle of the hinge part 28 relative to the mounting part 26 initially, the mounting part 26 in its overlapping region with the hinge part 28 is provided with projections 56 which correspond to the hinge part base 58. The projection 56 are dimensioned so that at a minimal angle between the mounting part 26 and the hinge part 28 they come to abutment against the hinge part base 58.

Naturally it is also possible to arrange a shackle 46 in the region of the wiper shaft 18. In this case the pulling spring 36 extends in an inner region of a mounting part 26. This case corresponds to a reverse option of the embodiment shown in FIG. 2. The shackle 46 is then arranged in the wiper shaft-side quarter of the mounting part 26 while the pulling spring 36 instead of the bracket 38 is hooked in the shackle 46 in this case. The C-shaped bracket 38 is only arranged in the region of the connection between the hinge part 20 and the mounting part 26, for preventing damages of the pulling means 34 during folding.

In principle, naturally it is possible to provide the shackle 46 or the mounting shackle 62 and/or further shackles of similar type only for mounting of the washing fluid hose.

It will be understood that each of the elements described above, or two or more together, may also find a useful application in other types of constructions differing from the types described above.

While the invention has been illustrated and described as embodied in wiper device, in particular for a motor vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A window wiper device for a motor vehicle, comprising a wiper arm having at least one hinge part and a mounting part hingedly connected with said hinge part; at least one pulling means which connects said mounting part with said hinge part, said mounting part having substantially a profile with a base and at least one lateral flank, said pulling means being mounted on said mounting part on a shackle extending from said lateral flank.

2. A window wiper device as defined in claim 1, wherein said shackle, starting from an edge of said lateral flank facing away from said base, extends substantially parallel to said base.

3. A window wiper device as defined in claim 1, wherein said shackle is formed of one piece with said mounting part.

4. A window wiper device as defined in claim 1, wherein said shackle is arranged at least in a hinged part-side half of said mounting part.

5. A window wiper device as defined in claim 1, wherein said shackle is arranged at least in a hinge part-side quarter of said mounting part.

6. A window wiper device as defined in claim 1, wherein said shackle has an opening for mounting said pulling means.

7. A window wiper device as defined in claim 1, wherein said pulling means include at least one pulling spring on which a C-shaped bracket is hingedly connected.

8. A window wiper device as defined in claim 6, wherein said opening is reinforced at least at a location contacting said pulling means.

9. A window wiper device as defined in claim 1, wherein said shackle has a supporting projection.

10. A window wiper device as defined in claim 9, wherein said supporting projection for supporting said shackle on said base extends from an edge of said shackle substantially perpendicular to said base.

11. A window wiper device as defined in claim 9, wherein said supporting projection and said base is arranged so that between a shackle-remote end of said supporting projection and said base a gap is provided.

12. A window wiper device as defined in claim 1, wherein said shackle has a projection.

13. A window wiper device as defined in claim 1, wherein said hinge part has a mounting shackle which encloses an angle with a hinge part flank, said shackle enclosing with said lateral flank a substantially identical angle.
